(19) United States
(12) Patent Application Publication
(10) Pub. No.: US 2005/0083970 A1
(43) Pub. Date: Apr. 21, 2005

(54) Apparatus, system and method of transmitting data

(76) Inventors: Jeff Glickman, Las Vegas, NV (US); Rene Poston, Portland, OR (US)

Correspondence Address: KOLISCH HARTWELL, P.C., 520 S.W. YAMHILL STREET, SUITE 200, PORTLAND, OR, 97204, US

(21) Appl. No.: 10/919,540

(22) Filed: Aug. 16, 2004

Related U.S. Application Data
(60) Provisional application No. 60/495,289, filed on Aug. 14, 2003.

(51) Int. Cl. H04L 12/66; H04J 3/16; H04J 3/22; H04J 3/24

(52) U.S. Cl. 370/466; 370/474

(57) ABSTRACT

A method of transmitting data between multiple nodes of a network system is provided. The method may include a packaging an initial bundle of data into a plurality of initial data packets and packaging supplemental data into a plurality of supplemental data packets. The method may further include transmitting the initial data packets using a first protocol and transmitting the supplemental data packets using a second protocol.

### TECHNICAL FIELD

The present disclosure relates generally to apparatus, systems and methods for transmitting data, and more specifically, to apparatus, systems and methods for reliably delivering data to a receiving device.

### BRIEF DESCRIPTION OF THE DRAWINGS

The disclosure is illustrated by way of example and not by way of limitation in the figures of the accompanying drawings, in which the like references indicate similar elements and in which:

FIG. 1 is a schematic illustration of an exemplary system into which an embodiment of the present disclosure may be implemented.

FIG. 2 is a flow chart of a method of data transmission for use in the exemplary system shown in FIG. 1 according to an embodiment of the present disclosure.

FIG. 3 is another flow chart further showing the steps of determining and correcting a transmission packet error according to an embodiment of the present disclosure.

FIG. 4 is a schematic illustration of data exchange from a client to a server.

FIG. 5 is another schematic illustration showing the cooperation between two different protocols to effectively and accurately transfer data according to an embodiment of the present disclosure.

### DETAILED DESCRIPTION

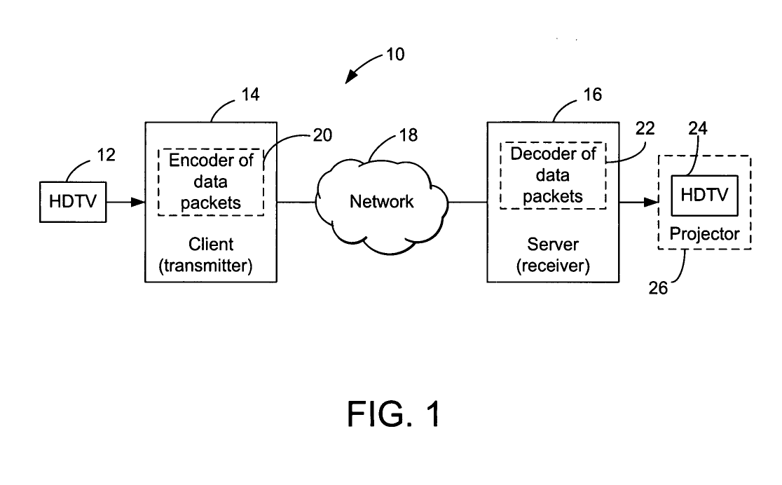

An exemplary system for use in transmitting data is illustrated schematically at 10 in FIG. 1. Data transmission within the system may be wireless, wired, fiber optic, a combination of wireless and wired, etc. It should be appreciated that the data transmitted in the system may be any suitable type of data, including, but not limited to, streaming data.

In the exemplary system, data or signals, such as high-definition television (HDTV) data 12 or other audio data, visual data, audio-visual data, video images, etc., may be read into a client, or transmitter 14. Client 14 may be adapted to transmit the data to server 16 via a network 18. Client 14 may be software, firmware, hardware, or a combination thereof. For example, client 14 may be any suitable computing device, such as a personal computer (PC), laptop, portable computer, personal data assistant (PDA), telephone, or other device with a suitable receiver configured to receive, or read data over a network, and a suitable processor configured to receive, collect and transmit streaming data to server 16. The client receiver and processor may be combined within the client element or program. In some embodiments, client 14 may be an application program loadable on a network or computing device linked to the network. It should be appreciated that in some embodiments, client 14 may be integrated/incorporated within a device, while in alternative embodiments client 14 may function as a stand-alone device.

Similarly, server 16 may be software, firmware and/or hardware. For example, server 16 may be a computing device or an application program. As with client 14, server 16 may be integrated within a device, such as a television, a computer, a projection device, etc. In some embodiments, server 16 may be an application program, such as a software program, that may be loaded into a playback device, such as a computer, projector, television, etc. In other embodiments, server 14 may be a stand-alone device that may be coupled to a playback device, such as a display device, television, computer, projector, etc. In some embodiments, the server may function as the playback device.

As discussed above, network 18 may be a wireless, fiber optic and/or a wired network or combination thereof. For example, client 14 may be physically connected to server 16. Alternatively, in some embodiments, client 14 may be in wireless communication with server 16 such that data and commands are sent between the client and the server wirelessly. Thus, network 18 may be any suitable transmissions network, including, but not limited to, wired networks, wireless networks, fiber optic networks, satellite broadcasts, computer networks, cable networks, etc.

In one embodiment of the present disclosure, client 14 may be adapted to receive streaming data, such as HDTV data. Such streamed data may be received by client 14, transmitted over a network 18, received by a server 16 and displayed as a video image. Consumers increasingly demand higher quality video images. Such high quality video images may require that large amounts of data be accurately manipulated and transmitted.

Any delay in the transmission, or reception of such streamed data may result in a delay in production of the image and may affect a consumer's perceived quality of the video image or the display device. Accurate manipulation and transmission of video data may require time, bandwidth and significant computing power. Attempts to speed up transmission by decreasing handling time may result in the mishandling and loss of data. Such mishandling of data may be apparent to a consumer.

Broadcast of video image signals, such as HDTV signals, may require additional data handling. Networks used for transmission of such signals typically require sufficient bandwidth to transmit the data. Moreover, to provide a smooth stream of video to an output device, the latency and/or jittering effect of the network must be minimized and/or made predictable such that any such effects may be accommodated during reproduction of the signal.

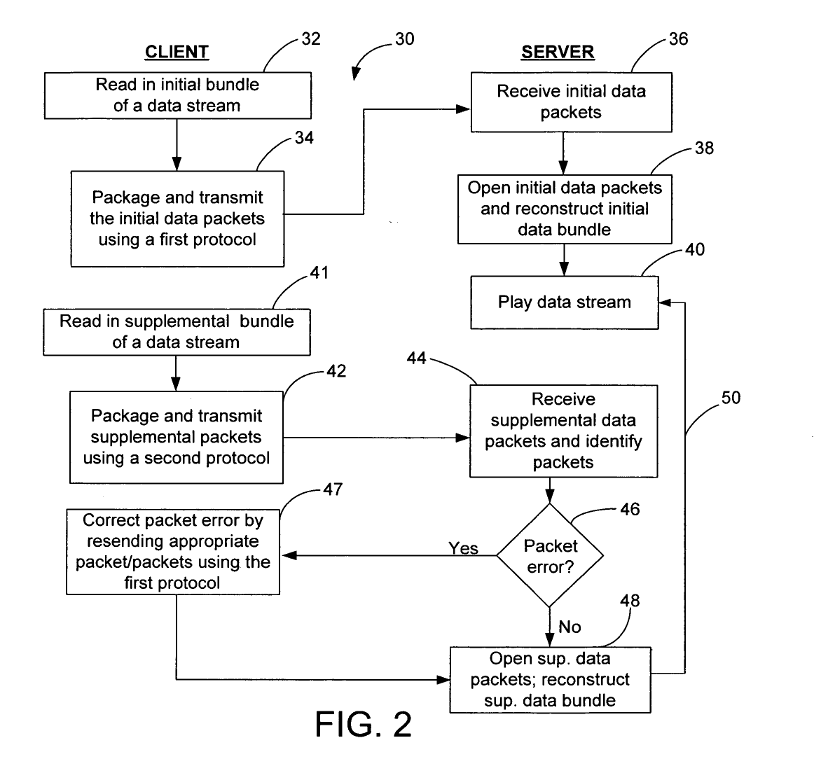

As shown generally in FIGS. 1 and 2, an embodiment of this disclosure serves to provide a layer on top of the network to enable transmission of a smooth stream of HDTV or other like signals over a network to a consumer. Upon receipt of the data, or data sequence, client 14 may be adapted to package the data into discrete packets. Packaging, as used herein, may include breaking the initial bundle into packets or blocks of data (packetizing), and serializing the packets or blocks, as described below.

For example, in the disclosed embodiment, each packet may be coded with an identifier. The identifier may include a serial number, sequence number or other similar code that identifies the sequential position of the packet relative to the other packets in the data stream. For example, in some embodiments, each discrete packet may include a monotonically ascending sequence number that correlates to the packets position in the original data stream. Alternatively, other types of sequence numbers or the like may be used.

After packetizing the data, the data packets may be transmitted from client 14 through network 18 to server 16. Server 16 may include a decoder 22 adapted to decode the data packets and organize the decoded data packets in the proper sequence, thus reconstructing the original data stream. The reconstructed data stream, or reconstructed data sequence, may then be played or reproduced via the server or another device, such as a playback device, display device, projector 26, television, computer, etc. As described briefly above, in some embodiments server 16 may be incorporated within the playback device. For example, server 16 may be integrated within projector 26.

FIG. 2 further illustrates a method 30 of data transmission for use in the exemplary system shown in FIG. 1. The method is described between a client and a server; however, it should be appreciated that the method may be implemented between any suitable modes, including but not limited to the client and server described herein. Specifically, as shown at 32, the client reads in an initial bundle of a data stream, or initial data sequence. The initial bundle or initial data sequence may be a predefined initial amount of a data stream, such as an HDTV stream. For exemplary purposes, and not as a limitation, the client may read in an initial one-second bundle of data. Alternatively, the client may read in more or less data to create the initial bundle.

After the initial data is read into the client, the client, at 34, may package the data in the initial bundle so as to form a plurality of packets. For example, a one-second initial bundle of data may be broken into thousands of packets. The packets may be any appropriate size. For example, in some embodiments, the packets may be 1472 bytes. As described above, each packet may include an identifier that identifies the sequential order of the packet relative to the other packets. The identifier may be of any suitable size, for example, a packet of 1472 bytes may include 1468 bytes of data and 4 bytes that operate as an identifier.

The first set of packets, or initial packets, which may be derived from the initial bundle, may be transmitted using a first communication protocol. As described in more detail below, the first protocol may be a reliable, but relatively slow protocol. For example, the first protocol may be any suitable protocol that guarantees substantially errorless delivery of the packets to the receiver. A suitable first protocol is dependable and reliable in that it may be depended to reliably deliver each packet to the server in the correct order, and thus may ensure proper reconstruction of the data stream by the server.

As an example, and not as a limitation, the first communication protocol may be one or more reliable protocols, such as Transmission Control Protocol (TCP), Internet Protocol (IP) or Transmission Control Protocol/Internet Protocol (TCP/IP). Regardless of the specific type of protocol, the first protocol is adapted to ensure delivery of the packets that comprise the initial bundle of data. The first protocol may be further adapted to ensure that the packets will be delivered in the order in which they were sent.

The server linked to the client may be adapted to receive the coded packets sent using the first protocol as indicated at 36. The server may be further configured to depacketize, or open the packets, and to reconstruct the initial data sequence, as shown at 38. Opening the packets may include decoding the packet identifier and arranging the data into a readable form. The depackatized initial data may be arranged to form a reconstructed initial data sequence, or a reconstructed initial data bundle. As shown at 40, the reconstructed initial bundle may then be played/reproduced by the server or a linked device.

After or substantially concurrently with packaging and transmitting the initial bundle of data, the client may package any additional or supplemental bundles of data into supplemental data packets, as shown at 41. These supplemental data packets may be transmitted from the client to the server using a second protocol, as shown at 42. The second protocol may be a faster protocol than the first protocol. Moreover, there is less need for the second protocol to be reliable. Thus, the second protocol may be a fast, but partially-unreliable protocol with few error recovery services, such as User Datagram Protocol (UDP).

The packets sent using the second protocol may be received and identified by the server, as shown at 44. As discussed above, each data packet may include an identifier which may be read by the server to identify the sequential position of a packet relative to other packets. The server may open, or unpack the data packets. As used herein unpack may include decoding the data packets, depackatizing the data packets, and organizing the decoded data packets into a proper sequence to reconstruct the data stream, or original data sequence provided to the client, as discussed below.

Once the packet is identified, the server may determine whether the received packet is the expected packet (at 46). If the packet is the expected packet, the packet may be opened and appended to the data stream, at 48, such that it may be played as part of the data stream in the proper sequence. It should be appreciated that the packets and/or reconstructed data stream may be temporarily held in a buffer or other temporary storage area on the server or linked device such that the data may be easily accessed when needed.

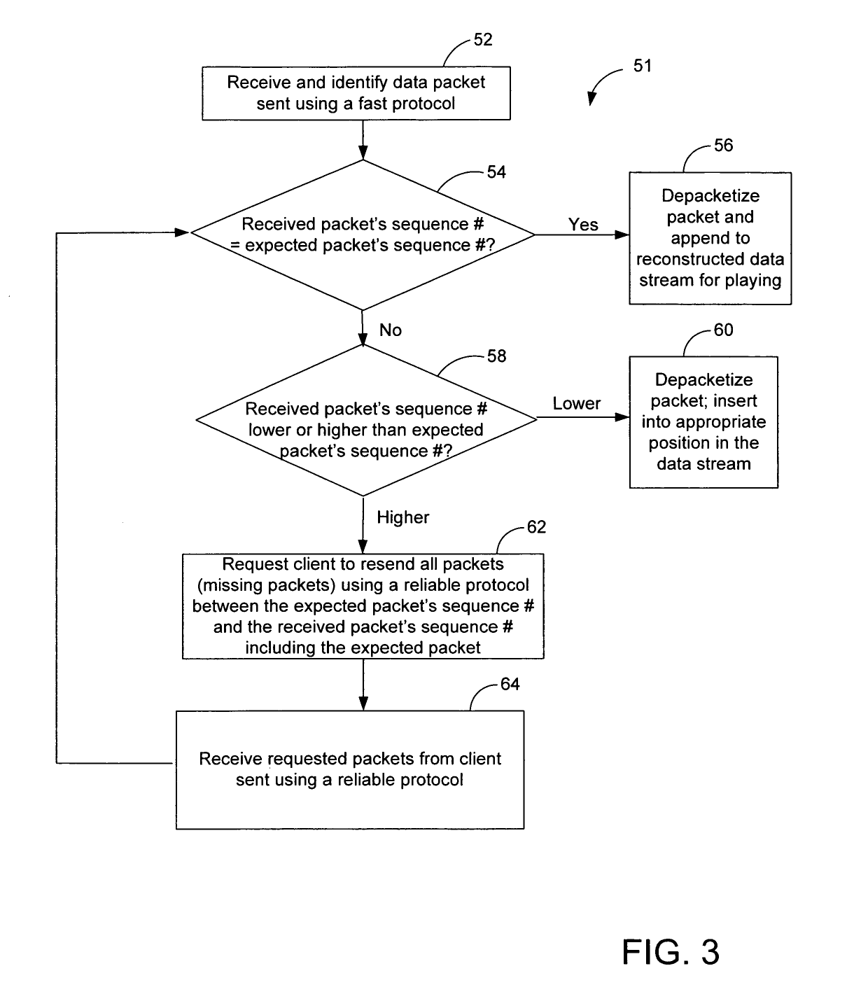

If the packet is not the expected packet, a transmission error may have occurred. If such a transmission and/or packet error has occurred, the server may automatically request the client to resend the desired packet/packets by sending the client a packet error message, or retransmit request, as described in more detail in FIG. 3. The client, at 50 in FIG. 2, may respond to the request of the server for the proper packets by resending the requested packet/packets using the first reliable (errorless) protocol instead of the second (faster) protocol. Upon receipt of the requested packets by the server sent using the first reliable protocol, the packets may be depacketized and appended to the data stream at 48 and played at 40.

FIG. 3 further illustrates an exemplary method, at 50, of generating a reliable data stream using a combination of multiple communication protocols. Specifically, a client may be configured to send data packets to a server using a fast protocol. A server linked to the client may be adapted to receive and identify data packets sent using the fast protocol, at 52. As described above, typically each packet includes an identifier, which may include a sequence number, which identifies the sequential position of the packet relative to other packets in a data stream. Thus, in determining the identifier of the received data packet, the sequential position of the packet within the data stream may be determined. If the packet is the expected packet, wherein the received packet's sequence number equals the expected packet's sequence number, then the received packet may be depacketized and appended to the reconstructed data stream, at 56.

In some situations, the packet may have an identifier that is sequentially lower or higher than the expected packet at 58. For example, if a received packet has a sequence number that is sequentially lower then the expected packet, the received packet may be depacketized and inserted into the appropriate position within the data stream, at 60. Thus, a packet that has been retransmitted may have a sequence number lower than the expected packet. If such a packet has been requested, the packet is depacketized and inserted into the queue in the appropriate position.

In some situations, the server may receive duplicate packets with identical sequence numbers. Such duplication may be an effect of the use of a fast, non-reliable protocol. Such duplicate packets may be ignored or otherwise discarded such that the reconstructed data stream does not contain two or more of the same packet.

In some situations, the received packet may have a sequence number that is sequentially greater (or higher) than the sequence number of the expected packet, (at 62). In such situations, the server may send a retransmit request (a command to the client to retransmit one or more packets). The retransmit request, or packet error message, may include a request that the client resend all packets (missing packets) between the sequence number of the expected packet and the sequence number of the received packet, including retransmission of the expected packet. Such a retransmit request may be sent using a reliable protocol, such as, but not limited to, TCP/IP ensuring that the client receives and correctly responds to the request. In response to the request, the missing packets may be transmitted from the client to the server using any suitable reliable protocol. Use of such a reliable protocol may ensure receipt by the server of the requested packets in the proper sequential order, as shown at 64.

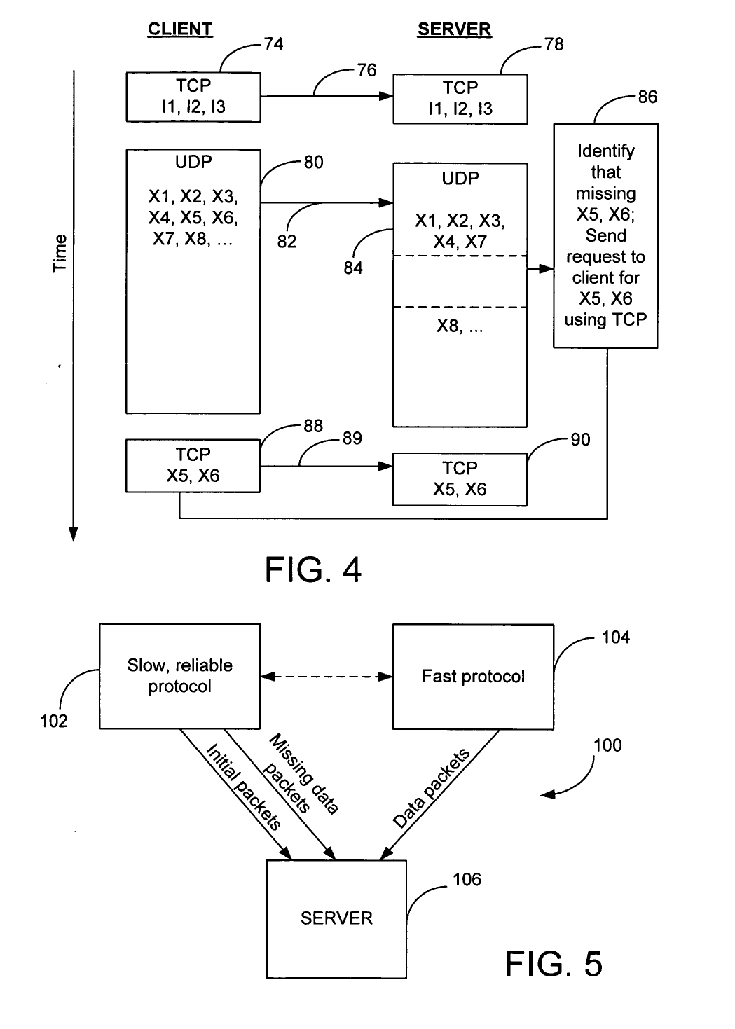

FIG. 4 is an exemplary illustration of the communication between a client and a server over time in accordance with one embodiment of the present disclosure. As discussed above, it should be appreciated that other types and number of communication protocols may be used in accordance with the disclosed method without departing from the scope of the disclosure.

As illustrated in FIG. 4, initiation of transmission of a data stream may begin with the client sending an initial set of data packets 74 (I1, I2, I3) from a data stream to the server (indicated by arrow 76) using a reliable protocol, such as TCP/IP. The server receives the TCP/IP data packets 78 (I1, I2, I3), depacketizes the packets and reconstructs the data into a playable data stream. The use of a reliable, substantially errorless protocol for the initial set of data ensures accurate initial transmission of the data stream. Accuracy in transmission of the initial set of data may outweigh speed of the transmission. Specifically, the speed of the initial transmission may have little effect on the quality of the reproduction of the initial part of the data stream. Moreover, because of the limited data being transmitted using the reliable protocol, bandwidth may be available for additional data to be transmitted.

However, transmission speed of the bulk of the data stream may be important in the quality of the reproduction. Thus, in some embodiments, a fast protocol may be used after transmission of the initial set of data packets. For example, UDP or other suitable fast protocol may be used to transmit the bulk of the data stream, as indicated at 80. For example, the data stream may be packetized into packets X1, X2, X3, X4, X5, X6, X7, X8, etc. and sent to the server (as indicated by arrow 82) using UDP. The use of UDP, or a similar fast protocol, may reduce the overhead within the system. For example, with UDP, the packets may be transmitted to the receiver blindly without the necessity of acknowledgement or authentication of the transmission between the client and server. Such blind transmission may reduce the amount of bandwidth necessary to transmit the data packets.

As shown at 84, the server is adapted to receive the UDP data packets. However, errors in transmission (including duplication of packets, losing packets, failure to transmit packets) may occur due to the speed and use of the, at least-partially unreliable, protocol. For example, the server may receive packets X1, X2, X3, X4, X7, X8, etc. but not packets X5, X6. Use of the packets' sequence numbers enables the server to identify the missing packets and send a retransmit request to the client for the missing packets (as shown at 86 and described in more detail above in relationship to FIG. 3). The retransmit request may request that the missing packets be sent using the reliable, errorless protocol, thus ensuring receipt of the packets, as indicated by arrow 89. Upon receipt of the retransmit request (at 88), the client may retransmit the missing packets (X5, X6) using the requested reliable protocol, such as TCP. Use of the slow, but reliable protocol substantially guarantees the receipt of the missing packets 90, thereby ensuring a correct reconstruction of the data stream. The combination of the fast and slow protocol may enable the display of an HDTV broadcast, or similar broadcast, without the latency, jittering and bandwidth issues of conventional methods and devices.

FIG. 5 further illustrates generally at 100 an exemplary relationship between multiple protocols in transmitting a data stream between a client and a server according to an embodiment of the present disclosure. Specifically, a slow, reliable protocol 102 and a fast (but sometimes unreliable) protocol 104 may be used in combination to ensure a fast, accurate transmission of data to a server 106. This combination of a reliable, slow protocol in parallel, or substantially parallel use with a fast, but partially-unreliable protocol results in an efficient, but accurate method of transmitting data over a network.

The types of protocols used may also vary depending on the type of data to be transmitted. For example, a slow protocol 102 may be used to transmit core data. Core data, as used herein, typically is data that requires errorless transmission. For example, core data may include the initial data packets. Moreover, core data may include data being retransmitted, such as missing data packets that are needed to accurately reconstruct a data stream.

In contrast, a fast protocol 104 may be used to transmit bulk data, such as supplemental data described above. Bulk data, as used herein, includes data that does not need to be transmitted with the same level of reliability as core data. For example, the majority of a data stream may initially be treated as bulk data. If errors occur in the sending and receiving of the bulk data, the data may be resent as core data using the slow reliable protocol 102. The cooperation between the two or more protocols in sending a data stream results in a substantially errorless, rapid transmission of data.

Although the present disclosure includes specific embodiments, specific embodiments are not to be considered in a limiting sense, because numerous variations are possible. The subject matter of the present disclosure includes all novel and nonobvious combinations and subcombinations of the various elements, features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring, nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of transmitting data between multiple nodes of a network system, the method comprising:
packaging an initial bundle of data into a plurality of initial data packets;
packaging supplemental data into a plurality of supplemental data packets;
transmitting the initial data packets using a first protocol; and
transmitting the supplemental data packets using a second protocol.

2. The method of claim 1 wherein the first protocol is comparatively more reliable than the second protocol, and is further comparatively slower than the second protocol.

3. The method of claim 1 wherein the method further comprises retransmitting a plurality of data packet using the first protocol upon receipt of a retransmit request.

4. The method of claim 1 wherein packaging includes separating a bundle of data into packets.

5. The method of claim 1 wherein packaging includes separating a data sequence into data packets and coding each data packet with a packet identifier.

6. The method of claim 5 wherein the packet identifier identifies the sequential position of an individual data packet relative to other data packets.

7. The method of claim 5 wherein the packet identifier includes a sequence number.

8. The method of claim 1 wherein the initial bundle of data and the supplemental bundle of data include audio data, video data, or a combination of audio and video data.

9. The method of claim 1 wherein the initial bundle of data and the supplemental bundle of data are high definition television data.

10. The method of claim 1 wherein the network system is a wireless network system.

11. A transmitter for transmitting data to a receiver over a network, the transmitter comprising:
a receiver configured to receive data sent over the network; and
a processor configured to package and transmit an initial data bundle using a first protocol, and is further configured to package and transmit a supplemental data bundle using a second protocol.

12. The transmitter of claim 11 wherein the first protocol is a reliable protocol.

13. The transmitter of claim 11 wherein the second protocol is comparatively less reliable than the first protocol.

14. The transmitter of claim 11 wherein the second protocol is comparatively faster than the first protocol.

15. The transmitter of claim 11 wherein packaging includes separating a bundle of data into packets and coding each packet with a packet identifier.

16. The transmitter of claim 15 wherein the packet identifier identifies the sequential position of an individual packet relative to other data packets.

17. The method of claim 15 wherein the packet identifier includes a sequence number.

18. The transmitter of claim 11 wherein the receiver is further configured to receive a retransmit request.

19. The transmitter of claim 11 wherein the processor is further configured to retransmit a data packet.

20. The transmitter of claim 11 wherein the processor is further configured to retransmit a supplemental data packet using the first protocol.

21. The transmitter of claim 11 wherein the data is high definition television data.

22. The transmitter of claim 11 wherein the network is a wireless network.

23. A method of receiving data between multiple nodes of a network system, the method comprising:
receiving a plurality of initial data packets transmitted over a network using a reliable protocol;
unpacking the initial data packets;
receiving a plurality of supplemental data packets transmitted over the network using a comparatively less reliable protocol; and
unpacking the supplemental data packets.

24. The method of claim 23 wherein unpacking includes decoding the data packets, depackatize the data packet, and organizing the decoded data packets in a proper sequence to reconstruct a data stream.

25. The method of claim 23 wherein the reliable protocol is comparatively slower than the comparatively less reliable protocol.

26. The method of claim 23 wherein the reliable protocol is TCP and comparatively less reliable protocol is UDP.

27. The method of claim 23 further comprising identifying an error in transmission and sending a retransmit request.

28. The method of claim 27 further comprising receiving a plurality of retransmitted data packets transmitted over a network using a slow protocol.

29. The method of claim 23 further comprising playing a reconstructed data stream on a playback device.

30. The method of claim 23 wherein the playback device is a display device.

31. The method of claim 23 wherein the plurality of initial data packets include core data requiring errorless transmission, and the plurality of supplemental data packets include bulk data that does not require errorless transmission.

32. The method of claim 23 wherein the plurality of initial data packets and the plurality of supplemental data packets contain high definition television data.

33. The method of claim 23 wherein the network system is a wireless network.

34. A playback device configured to receive data transmitted over a network system, wherein, the playback device comprises;
a receiver configured to receive a plurality of initial data packets transmitted over a network using a first protocol and to receive a plurality of supplemental data packets transmitted over a network using a second protocol, to unpack a plurality of data packets, and is further configured to arrange the initial and supplemental data packets into a reconstructed data bundle; and
a display configured to play the reconstructed data bundle.

35. The playback device of claim 34 wherein unpacking includes decoding the data packets, depackatizing the data packets, and organizing the data packets in a proper sequence to reconstruct the original data stream.

36. The playback device of claim 34 wherein the first protocol is more reliable than the second protocol, and is slower than the second protocol.

37. The playback device of claim 34 wherein the first protocol is more reliable than the second protocol, and is slower than the second protocol.

38. The playback device of claim 34 wherein the receiver is further configured to identify transmission errors and to send a retransmit request.

39. The playback device of claim 34 wherein the receiver is further configured to receive a plurality of retransmitted data packets transmitted over a network using a slow protocol.

40. The playback device of claim 34 wherein the playback device is a display device.
